(19) United States
(12) Patent Application Publication
(10) Pub. No.: US 2006/0198337 A1
(43) Pub. Date: Sep. 7, 2006

(54) Method and apparatus for operating a node in an ad-hoc communication system

(76) Inventors: Minh N. Hoang, Stoughton, MA (US); Daniel B. Grossman, Norwood, MA (US); George A. Harvey, Bedford, MA (US)

Correspondence Address: MOTOROLA, INC., 1303 EAST ALGONQUIN ROAD, IL01/3RD, SCHAUMBURG, IL, 60196, US

(21) Appl. No.: 11/073,894

(22) Filed: Mar. 7, 2005

(51) Int. Cl. H04Q 7/00; H04L 12/56; H04L 12/43

(52) U.S. Cl. 370/329; 370/400; 370/458

(57) ABSTRACT

A method and apparatus (500) for operating a node within an ad-hoc communication system (100) is provided herein. A single-radio relay node (500) is used to link overlapping piconets operating on different radio channels. All nodes (203-208) within the ad-hoc communication system (100) operate on multiple channels, which differ for each associated piconet (201, 202). When relaying data between piconets, a node's transceiver (505) will be receiving data during a first time period on a first channel (the data transmitted from a first node existing in a first piconet). During a second time period, the transceiver (505) will relay the data over a second channel to a second node existing in a second piconet.

### FIELD OF THE INVENTION

The present invention relates generally to ad-hoc communication systems, and in particular, to a method and apparatus for operating a node in an ad-hoc communication system.

### BACKGROUND OF THE INVENTION

Ad-hoc wireless transmission technology offers very high rate throughput but within a limited distance, typically 10 meters or less between devices in each piconet. To extend network coverage (e.g., to provide whole house coverage), additional piconets must be added and linked (meshed) together. Meshing typically requires all transmissions to use the same radio channel. Using the same radio channel for all transmissions allows for a single transceiver to operate within each node, reducing costs. This simple scheme is not scalable beyond a few piconets since each additional piconet further reduces the average available channel time to each device in the overall network. For example, it has been shown that as the node density increases, the network performance is rapidly degraded due to channel contention. This is because when two nodes in close proximity are communicating, use of the common channel has the effect of preventing multiple surrounding nodes from communicating amongst them. This creates a ripple effect on the congestion in the network. Therefore, a need exists for a method and apparatus for operating a node in an ad-hoc communication system that alleviates congestion caused by the use of a common channel.

### BRIEF DESCRIPTION OF THE DRAWINGS

FIG. 1 is a block diagram of a communication system.

FIG. 2 is a more-detailed block diagram of the communication system of FIG. 1.

FIG. 3 illustrates a transmission scheme for the communication system of FIG. 1.

FIG. 4 illustrates a possible channel timing diagram for multihop operation the communication system of FIG. 2.

FIG. 5 is a block diagram of a node within the communication system of FIG. 1.

FIG. 6 is a flow chart showing operation of the node of FIG. 5.

FIG. 7 is a flow chart showing operation of the node of FIG. 5.

### DETAILED DESCRIPTION OF THE DRAWINGS

To address the above-mentioned need a method and apparatus for operating a node within an ad-hoc communication system is provided herein. A node having a single radio is used to link overlapping piconets operating on different radio channels. All nodes within a piconet operate on a single channel, which differs for various piconets in the network. When relaying data between piconets, a node's transceiver will be receiving data during a first time period on a first channel (the data transmitted from a first node existing in a first piconet). During a second time period, the transceiver will relay the data over a second channel to a second node existing in a second piconet. Since all nodes within a given piconet will transmit and receive on a particular channel, and since neighboring piconets will operate on different channels, the network performance is not degraded due to channel contention.

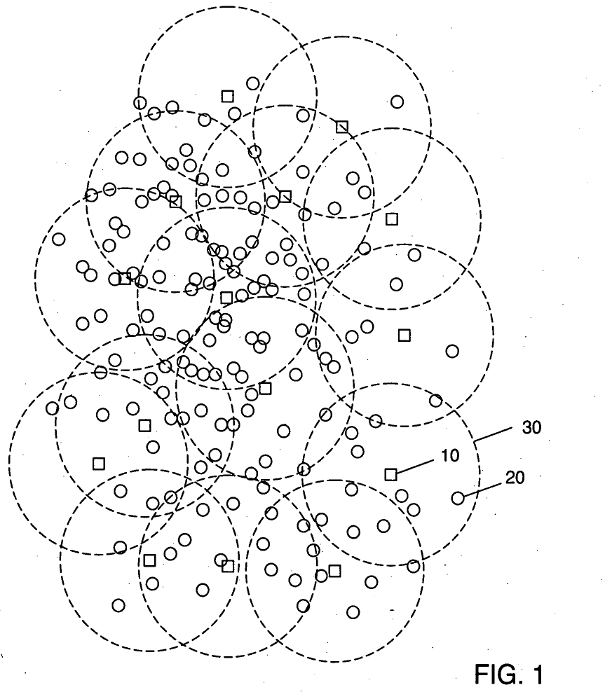

Turning now to the drawings, wherein like numerals designate like components, FIG. 1 illustrates communication system 100 in accordance with the preferred embodiment of the present invention. Communication system 100 preferably utilizes a communication system protocol defined by the 802.15.3 Wireless Personal Area Networks for High Data Rates standard, or the IEEE 802.15.4 Low Rate Wireless Personal Area Networks standard. One of ordinary skill in the art will recognize that other communication system protocols may be utilized without varying from the scope of the invention. For example, communication system 100 may utilize communication system protocols such as, but not limited to, Ad-hoc On Demand Distance Vector Routing (AODV), Dynamic Source Routing (DSR), Temporally-Ordered Routing Algorithm (TORA), BluetoothTm standard (IEEE Standard 802.15.1), . . . , etc. As shown, communication system 100 includes a number of piconets, each comprising a coordinating device 10 and a larger number of slave nodes 20 in communication with coordinating device 10. Nodes 20 represent devices that communicate with each other through synchronization provided by coordinating devices 10. Nodes 20 can be transportable (mobile) or they can be fixed in a given place.

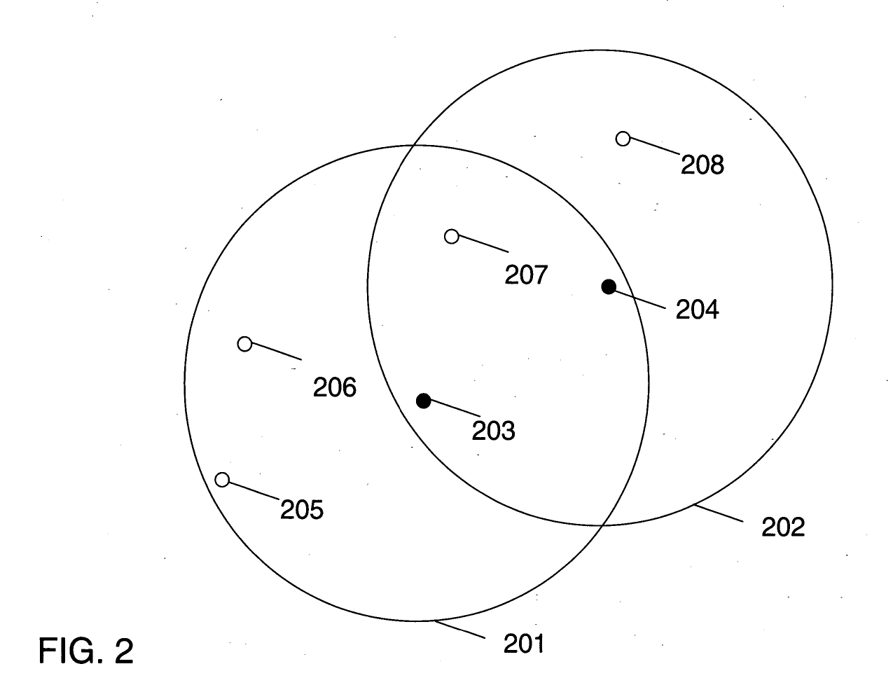

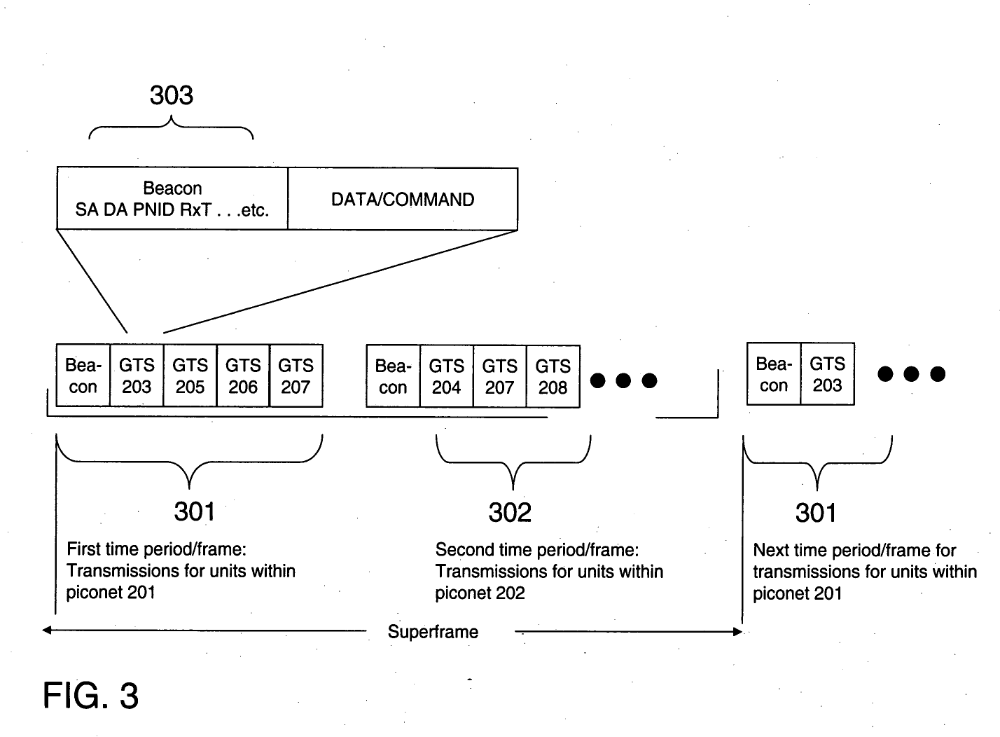

Prior to describing techniques for alleviating congestion within network 100, it is necessary to set forth some background information with the following definitions, and with reference to FIG. 2 and FIG. 3.

Hop: A direct link between a transmitter and a receiver.

Radio channel: A wireless physical path. Separation can be by frequency division (like 802.11) or CDMA spread sequence (like DS-UWB).

Radio: A transceiver that operates on only one radio channel at a time, capable of switching channels with some switching delay. The radio typically operates half-duplex, transmit or receive (or idle/off) but not both concurrently.

Relay Node: A node that participates concurrently in multiple independent piconets capable of transferring data between them.

Frame: A time period when all transmit/receive operations take place within a piconet.

Superframe: Time period between beacons of a piconet. Note that when there is only one piconet on a particular radio channel, its frame may be as large as its superframe.

FIG. 2 is a more-detailed view of system 100, showing two piconets 201 and 202 having respective controllers 203 and 204. In this illustration, nodes 205-207 are associated with controller 203 (piconet 201), while nodes 207-208 are associated with controller 204 (piconet 202). As is evident, node 207 acts as a relay node, participating in both piconets 201 and 202, and relaying data between nodes in each piconet.

FIG. 3 illustrates a transmission scheme for the communication system of FIG. 2. During communications among nodes 201-208, a specific transmission protocol is utilized by communication system 100 wherein each piconet communicates within a particular non-overlapping frame 301, 302 as described in U.S. patent application Ser. No. 10/414,838, which is incorporated by reference herein. With reference to FIG. 2, piconet 201 completes all necessary transmissions within frame 301, while piconet 202 completes all necessary transmissions within frame 302. During a frame, a particular controller of the piconet will broadcast piconet timing and control information within a beacon field, while each node (including the controller) will have a Contention Free Period slot, part of the Channel Time Allocation (CTA) facility of the IEEE 802.15.3 standard, for transmission. During its guaranteed time slot, a particular node broadcasts any command (COM) wishing to be executed to any particular node or may send/receive data intended for a single node or set of nodes. Note that because node 207 participates in each piconet, node 207 has a guaranteed time slot (GTS) for transmission/reception within each piconet's frame.

During the GTS, the node also broadcasts a beacon comprising identification of the piconet(s) a node is associated with (i.e., a piconet identifier (PNID)), along with a source address (SA, or device identifier (DEVID)), a destination address (device identifier (DA or DEVID)), and a receive time (R×T) when the node can receive other node's transmissions. This is illustrated in FIG. 3 with the expanded view of the GTS for node 205. It should be noted that although FIG. 3 shows the beacon signal comprising SA, DA, PNID, and R×T, one of ordinary skill in the art will recognize that the beacon signal may comprise other elements such as, but not limited to, the byte length of the frame being used, a beacon payload that can be used to broadcast generic data, . . . , etc.

As discussed above, networks operating on a single frequency are not scalable beyond a few piconets since each additional piconet further reduces the average available channel time to each device of the overall network. In order to address this issue, a single-radio relay node (RLY) is used to link overlapping piconets operating on different radio channels. This is possible under single-coordinator time-division medium access control schemes. Because relay nodes have only a single radio, the system requires coordination between piconets to ensure that the relay nodes are active (transmit or receive) in only one piconet at a time. More particularly, each coordinator will schedule transmission/reception times for the relay node so that they will not overlap. Thus, node 207 (acting as a relay node) will need to operate on two different channels, one for piconet 201 and one for piconet 202. When relaying data between each piconet, node 207 will be receiving data at a transceiver, the data transmitted from a first node existing in a first piconet, and received on a first channel. The data will be relayed by the transceiver to a second node existing in a second piconet on a second channel. The radio (transceiver) within node 207 must be operable on multiple channels, one channel at a time. Channel switching must be accomplishable under program control. Channel switching time must be sufficiently rapid, on the order of a few short interframe spacing (SIFS) periods of the applicable radio medium access control (MAC) protocol, to support multiple channel changes per superframe time. Current state-of-the-art radios, such as one based on the IEEE 802.15.3 standard, should readily satisfy these requirements.

Since all nodes within a given piconet will transmit and receive on a particular channel within a frame, and since relay nodes must monitor the beacons of all the piconets it is spanning with only one radio, those beacons must occur at different times-preferably spaced far enough to allow sufficient channel switching time. Thus, relay nodes will listen to a first beacon from a first piconet on a first channel at a first period of time (start of first frame), and then switch to a second channel, listening for a second beacon from a second piconet, at a second time period (start of second frame). Thus, it follows that the meshing piconets must use the same superframe period and maintain beacon synchronization and spacing.

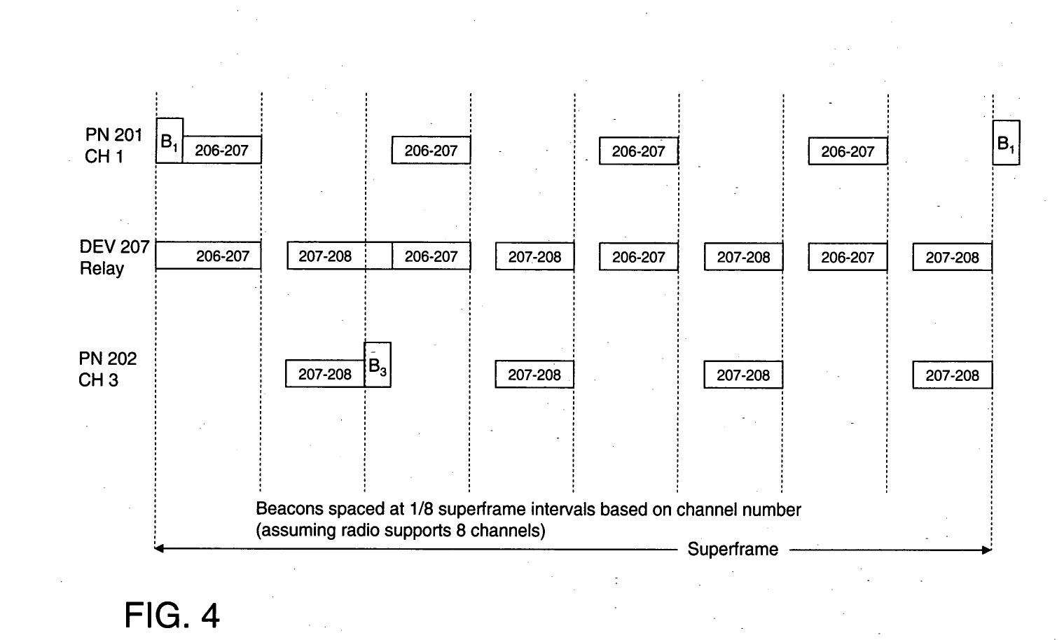

On start up, each PNC scans the radio channels for pre-existing piconets and selects an unused channel for its piconet. If there is no unused channel, it then follows the child/neighbor piconet startup procedure as defined in IEEE 802.15.3. If there is no pre-existing piconet or no piconet which meshing is desired, the PNC sets up its own piconet in independent mode with a self-selected superframe size. Operation then continues as defined in 802.15.3 for a PNC. If there are one or more existing piconets & meshing is desired, the PNC selects a reference piconet, monitors its beacon to get the superframe size and uses the same superframe size for its own piconet. The PNC applies a fixed delay from the reference beacon to its own beacon in its own channel. One method of generating non-overlapping delays is to use the radio channel number to space the beacons within a superframe. For example, if the radio supports 8 channels, then the beacons are placed at ⅛ superframe spacing, in order of channel 1, 2, to 8. The PNC monitors the reference beacon (requiring a switch to the reference's radio channel and back) every superframe and follows the reference's superframe size in case it changes. FIG. 4 shows a possible channel timing diagram for network 100 to permit maximum throughput over a multi-hop link between nodes 208 and 206, using node 207 as a relay node. Assuming the radio system supports 8 channels and piconets 201 and 202 use channel 1 and 3 respectively. The beacons will placed at ⅛ superframe intervals based on the channel number. Thus, the beacon for channel 3 will be placed at ¼ (2*⅛) superframe delay from channel 1's beacon. The scheduling shown requires an average of 1 radio channel switch at every beacon spacing interval (⅛ superframe). Other channel time allocations are possible if the amount of channel switching should be minimized. Each channel is occupied only about half of the time for the multi-hop link. The remaining time, depicted as blank areas in the channel-specific (CH x) time line, is available for other traffic.

During operation all relay nodes tell their associated mesh-capable piconet controllers (MPNC) (typically two MPNCs) of their availability status so that the MPNCs can schedule the relay node's active channel time at a non-conflicting spot in their own networks. For 802.15.3, this protocol is an extension of existing device-to-piconet-controller (DEV-PNC) communications. Additionally, the channel time reservation and assignment will require receivers' participations. A CTA is granted when both source and all destinations are available. For 802.15.3, the protocol may involve extensions of existing DEV-PNC communications. The network scheduler must be aware of meshing constraints (a relay node being busy during its other piconets' beacon times and activities). Finally, a traditional 802.15.3 device (DEV) will be compatible with the MPNCs and RLYs but its throughput performance may be improved if it adds a protocol to request and assign channel time for transmission between a source and one or more destinations within a piconet.

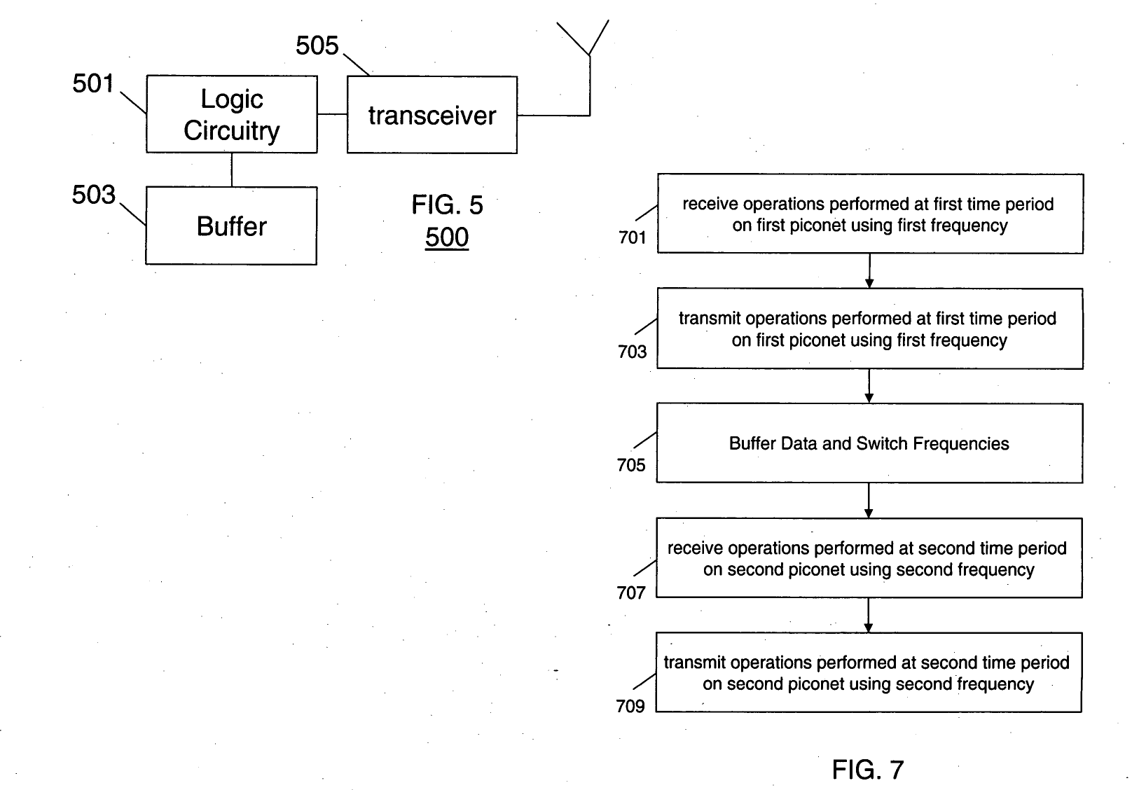

FIG. 5 is a block diagram of node 500. As is evident, node 500 comprises logic circuitry 501, buffer 503, and single radio (transceiver) 505. Node 500 may serve as a PNC, a relay node, or simply serve as a non-relaying node under a particular PNC. During operation as a PNC, logic circuitry 501 determines if there are one or more existing piconets within range and if so, selects monitors the piconets' beacons to get their frequency and frame location. Logic circuitry 501 then determines its own frequency of operation and frame location for its own piconet. Member recruitment then takes place.

When operating as a relay node, logic circuitry 501 must associate with at least two piconets. In doing so, node 500 will be given a timeslot for transmission and a timeslot for reception within each piconet's frame. When relaying between the two piconets, transceiver 505 will be receiving data from a first node on a first channel, existing in a first piconet, buffering the data, and relaying the buffered data on a second channel to a second node existing in a second piconet.

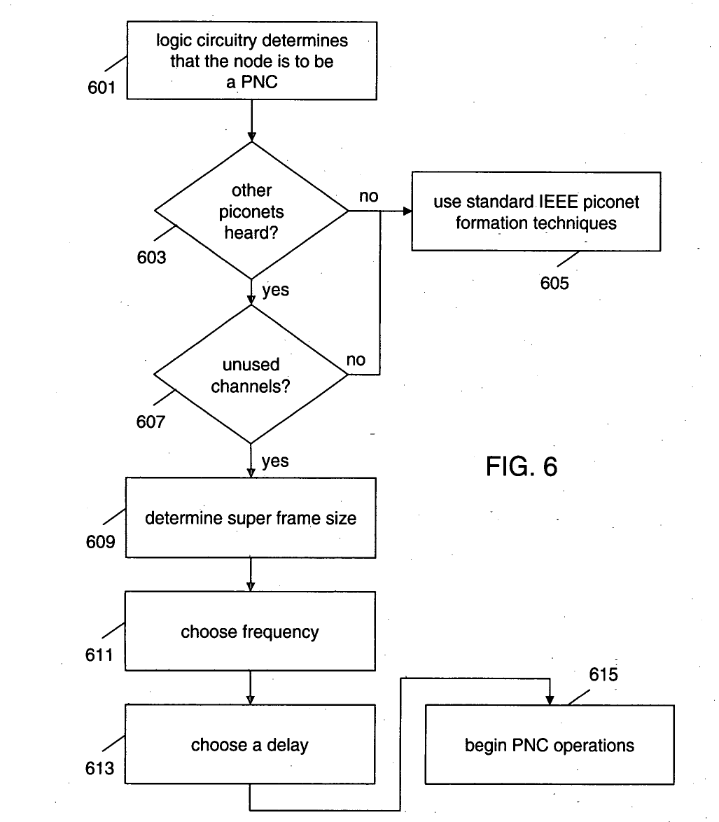

FIG. 6 is a flow chart showing operation of node 500 when acting as a PNC. The logic flow begins at step 601 where logic circuitry 501 determines that node 500 is to become a PNC. This procedure is defined in IEEE 802.15.3. At step 603 logic circuitry 501 determines if any other piconets are within range. This is accomplished by circuitry 501 instructing transceiver 505 to scan available channels to determine if any other piconet controllers' beacons are heard. If, at step 603 it is determined that no other piconets are heard, the logic flow continues to step 605 where standard IEEE 802.15.3 formation techniques are utilized to form a piconet. If, however, at step 603 it is determined that other piconets are heard, the logic flow continues to step 607 where logic circuitry 501 determines if any unused channels exist. If at step 607 it is determined that channels are not available, the logic flow returns to step 605 where the child/neighbor piconet startup procedure is executed as defined in IEEE 802.15.3.If, however, it is determined that channels are available, the logic flow continues to step 609 where logic circuitry 501 selects a reference piconet, monitors its beacon to get the superframe size and uses the same superframe size for its own piconet. A frequency of operation is chosen by logic circuitry 501 (step 611) and a fixed delay from the reference beacon is chosen (step 613) for beacon transmissions. As discussed above, the fixed delay is based on the frequency of operation with beacons being placed at 1/n superframe intervals (with n being the number of channels utilized by the system). Finally PNC operations begin at step 615.

FIG. 7 is a flow chart showing operation of node 500 when participating in more than one piconet. As discussed, a node participating in more than one piconet can relay data from one piconet to another. The participation in more than one piconet requires that transceiver 505 switch frequencies for each piconet's beacon being monitored. Additionally, as discussed above, node 500 will be assigned a time slot for transmit/receive operations within each piconet's frame. To prevent the overlapping of any transmission and reception between each piconet, the two piconet controllers will have communicated among themselves to determine a first and a second timeslot for transmission. The logic flow begins at step 701 where during a first time period (part of first piconet's frame) transceiver 505 performs receive operations for a first piconet using a first channel (e.g., frequency or spreading code). It is during this time period that any data to be transmitted to node 500 takes place from nodes participating in the first piconet.

At step 703 transmit operations are performed by transceiver 505 during the first time period on the first piconet using the first channel. It is during this time period that data is transmitted by node 500 to nodes participating in the first piconet. At step 705 logic circuitry 501 buffers any data to be transmitted to the second piconet and transceiver 505 switches frequencies and begins receive operations on the second piconet (step 707). Transceiver 505 uses a second channel and a second time period (part of second piconet's frame) to receive data from nodes participating in the second piconet. Finally, at step 709 during the second time period transceiver 505 performs transmit operations for the second piconet using the second channel. It is during this time period that any data buffered data to be transmitted from node 500 takes place from nodes participating in the second piconet.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for operating a node within an ad-hoc communication system, the node having a single transceiver, method comprising the steps of:
receiving with the transceiver, transmissions from a first piconet on a first channel within a first time slot;
transmitting with the transceiver, to nodes within the first piconet, wherein the transmission takes place on the first channel within the first time slot;
changing an operating channel of the transceiver;
receiving with the transceiver, transmissions from a second piconet on a second channel within a second time slot; and
transmitting with the transceiver, to nodes within the second piconet, wherein the transmission takes place on the second channel within the second time slot, wherein the first and the second time slots are assigned by two piconet controllers so that they do not overlap.

2. The method of claim 1 wherein the step of receiving transmissions from the first piconet comprises the step of receiving within the first time slot, wherein the first time slot is part of a superframe.

3. The method of claim 2 wherein the step of receiving transmissions from the second piconet comprises the step of receiving within the second time slot, wherein the second time slot is part of the superframe.

4. The method of claim 1 wherein the step of changing the operating channel of the transceiver comprises the step of changing an operating frequency.

5. The method of claim 1 wherein the step of changing the operating channel of the transceiver comprises the step of changing spreading code.

6. A method for operating a node within a communication system, the method comprising the steps of:
determining that the node is to become a piconet controller;
determining if other piconets are within communication range;
determining unused channels for the other piconets;
determining a superframe size;
determining a frequency of operation; and
choosing a beacon transmit and receive period within the superframe based on the frequency of operation and the superframe size.

7. The method of claim 6 wherein the step of determining the superframe size comprises the step of determining the superframe size by analyzing transmission from a second piconet controller.

8. The method of claim 6 wherein the step of choosing the beacon transmit and receive period comprises the step of choosing a transmit and receive period from a plurality of transmit and receive periods spaced at 1/n intervals within the superframe (with n being a number of channels).

9. A transceiver comprising:
receive circuitry for receiving transmissions from a first piconet on a first channel within a first time slot and receiving transmissions from a second piconet on a second channel within a second time slot; and
transmit circuitry for transmitting to nodes within the first piconet on the first channel within the first time slot and transmitting to nodes within the second piconet on the second channel within the second time slot.

10. The transceiver of claim 9 wherein the first time slot is part of a superframe.

11. The transceiver of claim 10 wherein the second time slot is part of the superframe.

12. The transceiver of claim 9 wherein the first and the second channels comprise a first and a second frequency.

13. The transceiver of claim 9 wherein the first and the second channels comprise a first and a second spreading code.
